(19) United States
(12) Patent Application Publication
(10) Pub. No.: US 2019/0214893 A1
(43) Pub. Date: Jul. 11, 2019

(54) WIRE OUTLET NOZZLE ARRANGEMENT

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 16/218,184

(22) Filed: Dec. 12, 2018

(30) Foreign Application Priority Data
Jan. 11, 2018 (EP) 18151158.5

(51) Int. Cl. H02K 15/04; H02K 15/00; B65H 51/10; B21B 27/02; B21B 17/10

(52) U.S. Cl. CPC H02K 15/0478; H02K 15/0081; B65H 2701/36; B21B 27/025; B21B 17/10; B65H 51/10

(57) ABSTRACT

A wire nozzle outlet arrangement includes a plurality of wire nozzle outlets situated parallel to one another. The wire outlet nozzles each guide a winding wire in a wire feed direction, wherein the wire outlet nozzles include an outlet opening, through which the winding wire guided in the wire outlet nozzle exits the respective wire outlet nozzle. The wire outlet nozzle arrangement includes a repositioning device, which is designed to change the sequence of the wire outlet nozzles by repositioning the wire outlet nozzles.

### CROSS REFERENCE TO RELATED APPLICATIONS

This patent application claims priority on and the benefit of European Patent Application No. 18151158.5 having a filing date of 11 Jan. 2018.

### BACKGROUND OF THE INVENTION

### Technical Field

The invention relates to a wire outlet nozzle arrangement, including a plurality of wire nozzle outlets situated parallel to one another, each of which guides a winding wire in a wire feed direction, wherein the wire outlet nozzles include an outlet opening, through which the winding wire guided in the wire outlet nozzle exits the respective wire outlet nozzle.

### Prior Art

In winding methods, in particular in the production of wave windings, a winding wire or a plurality of parallel winding wires is fed from wire outlet nozzles to a body to be wound.

In the method described in EP 3 182 568, a plurality of winding wires is fed from a generic wire outlet nozzle arrangement to the rotating shaping core of a winding device. The wire located on the shaping core is grasped by means of grippers and moved in a transport direction and the shaping core is rotated to produce the winding heads of the wave winding. In the process, a wave winding is produced on the shaping core, which is then transferred in a transport direction. The transport device rotates synchronously with the shaping core, so that the resultant wave winding may be continuously produced. With this device, it is possible to shape winding mats in any length with a relatively small shaping core.

Since a plurality of wires is fed in the known method, wires of different phases of the wave winding formed by the winding are necessarily situated next to one another. It then depends on the electrical component to be fitted with the wave winding as to how the individual phases are interconnected. For the design of the resulting winding it may therefore be necessary to interchange individual phases during the production of the wave winding.

### BRIEF SUMMARY OF THE INVENTION

The object of the present invention, therefore, is to specify a wire outlet nozzle arrangement of the aforementioned kind, with the aid of which an interchanging of phases may be carried out.

This object is achieved by a wire outlet nozzle arrangement, including a plurality of wire nozzle outlets situated parallel to one another, each of which guides a winding wire in a wire feed direction, wherein the wire outlet nozzles include an outlet opening, through which the winding wire guided in the wire outlet nozzle exits the respective wire outlet nozzle, characterized in that the wire outlet nozzle arrangement includes a repositioning device, which is designed to change the sequence of the wire outlet nozzles by repositioning the wire outlet nozzles, as well as by a wave winding device including a wire outlet nozzle arrangement as disclosed herein. Advantageous embodiments are found in the dependent claims.

The wire outlet nozzle arrangement according to the invention is able during the process to interchange wires within a winding strand. For this purpose, the wire outlet nozzle arrangement includes a plurality of wire outlet nozzles situated parallel to one another, each of which feeds a winding wire in a wire feed direction, wherein the wire outlet nozzles include an outlet opening, through which the winding wire fed in the wire outlet nozzles exits the respective wire outlet nozzle. The number of wire outlet nozzles corresponds preferably to a multiple of the phases to be provided in the winding mat, which is composed of a plurality of wave windings. According to the invention, it is now provided that the wire outlet nozzle arrangement includes a repositioning device, which is designed to change the sequence of the wire outlet nozzles by repositioning the wire outlet nozzles. The sequence of the wire outlet nozzles within the meaning of the invention means the sequence of the wire outlet nozzles adjacent to one another.

The wire outlet nozzle arrangement according to the invention is equally suitable for traditional round wires, i.e., wires having a circular cross section, as well as for flat wires. According to one particular embodiment, it is provided that the outlet openings of the wire outlet nozzles have a rectangular cross section, in which case the winding wire also has a rectangular cross section.

The wires may be repositioned in different ways. According to one particularly preferred embodiment, it is provided that the wire outlet nozzle arrangement includes at least two repositioning shafts that are each rotatably mounted about an axis perpendicular to the wire feed direction and spaced apart from one another, between which the wire outlet nozzles are situated. The repositioning shafts may each separate some of the wire outlet nozzles from the other wire outlet nozzles. In this way, therefore, the one repositioning shaft may grasp a first number of nozzles and the other repositioning shaft may grasp a second number of nozzles and through reciprocal movement of the repositioning shafts, it is possible to change the sequence. For this purpose, it is preferably provided that the first repositioning shaft grasps the 1^{st}, 3^{rd}, 5^{th}, etc. nozzle of the original arrangement, while the second repositioning shaft accordingly grasps the 2^{nd}, 4^{th}, 6^{th}, etc. nozzle of the original arrangement. In this way, there is in each case always space available between the nozzles on a repositioning shaft for accommodating a nozzle. If the repositioning shafts are then moved relative to one another, for example, by the width of two nozzles, this results, for example, in a new sequence, in which the nozzle sequence is then 2, 1, 4, 3, 6, 5, etc. For this purpose, it is preferably provided that the repositioning shafts are designed so as to be movable relative to one another parallel to their longitudinal direction of extension, respectively, perpendicular to the wire feed direction. For this purpose, it is sufficient if at least one of the repositioning shafts is mounted so as to be movable in a direction parallel to the wire feed direction.

The repositioning shafts according to the invention may include different means in order to grasp the corresponding nozzles. According to one preferred embodiment of the invention, it is provided that the repositioning shafts comprise a plurality of indentations positively engaging with the outsides of the wire outlet nozzles. Each of the nozzles is then situated in one of these indentations and forms a positive-locking fit. This may prevent the nozzles from slipping in the axial direction of the repositioning shaft. According to one particularly preferred refinement of the present invention, it is provided that both repositioning shafts each include cams spaced apart from one another along their direction of longitudinal extension. On the one hand, these cams serve to separate individual nozzles from one another. On the other hand, they are designed in such a way that they are able to engage in the intermediate spaces between two cams of the respective other repositioning shaft. As a result, the nozzles can be separated in the manner described above by rotating both repositioning shafts so that the respective cams abut against a nozzle in a cam intermediate space in the respective other repositioning shaft. The cams of the two repositioning shafts are therefore situated offset relative to one another, in each case by one nozzle width. If, therefore, the repositioning shafts are rotated accordingly, the cams of the first repositioning shaft abut the nozzles in the second repositioning shaft, and vice versa. At the same time, the two repositioning shafts may be moved against one another perpendicularly to their axial direction, so that the nozzles previously situated next to one another are now situated one on top of the other in a comb-like manner. Thus, the odd numbered nozzles, starting from the initial configuration, are separated by the even numbered nozzles. This is followed by a movement of both nozzles relative to one another and, in the process, the two shafts are again moved toward one another, wherein they are rotated simultaneously, so that the cams are disengaged from the respective nozzles. In this case, it is preferably provided that the spacing between the cams is selected so that precisely one wire outlet nozzle occupies space between the former.

According to one particular embodiment of the present invention, it is provided that the embodiment comprises a drive means, which drives the repositioning shafts in a rotating manner. The drive may also comprise, in addition, an adjustment perpendicular to the respective axis of the repositioning shafts; however, it is also conceivable that the repositioning shafts are movable passively—for example, against a spring pre-tensioning—in the direction perpendicular to the axial direction. In this case, the cams force the two repositioning shafts apart and when rotated back, the two shafts are pressed together again.

The wire outlet nozzle arrangement described above is suited in particular, for use in a wave winding device.

### BRIEF DESCRIPTION OF THE DRAWINGS

The invention is explained in greater detail below with reference to FIGS. 1-9.

FIG. 1 shows a schematic perspective representation of a wire outlet nozzle arrangement according to the invention,

FIG. 2 shows a cross sectional view through a part of the wire outlet nozzle arrangement according to the invention in the area of the repositioning shafts in an initial position,

FIG. 3 shows a cross section through the repositioning shafts in FIG. 2,

FIG. 4 shows a cross sectional view through a part of the wire outlet nozzle arrangement according to the invention in the area of the repositioning shafts in the pick-up position,

FIG. 5 shows a cross section through the repositioning shafts in FIG. 4,

FIG. 6 shows a cross sectional view through a part of the wire nozzle outlet arrangement according to the invention in the area of the repositioning shafts in the movement position,

FIG. 7 shows a cross section through the repositioning shafts in FIG. 6,

FIG. 8 shows a cross sectional view through a part of the wire outlet nozzle arrangement according to the invention in the area of the repositioning shafts in the end position, and

FIG. 9 shows a cross section through the repositioning shafts in FIG. 8.

### DETAILED DESCRIPTION OF PREFERRED EMBODIMENTS

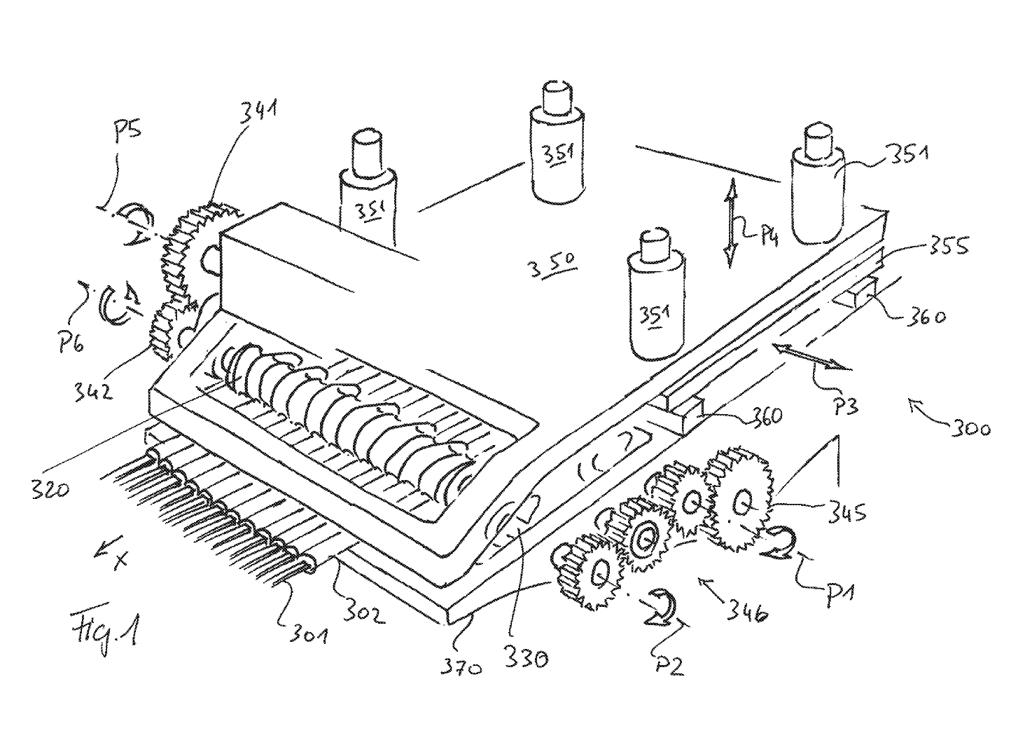

The wire outlet nozzle arrangement 300 represented schematically in FIG. 1 includes a plurality of wire outlet nozzles 302 situated next to one another, from which corresponding winding wires 301 are fed in feed direction X. Also apparent is a first repositioning shaft 320, which rests on the wire outlet nozzles 302, the repositioning shaft 320 also including groove-like indentations, which positively attach to the outer contours of the wire outlet nozzles 302. A similar repositioning shaft 330 is similarly designed and abuts the nozzles 302 below the same. The repositioning shafts 320, 330 are henceforth also referred to as “shafts” for short. The shaft 320 is rotatably mounted about the axis P6 and in the present case is driven via a drive train, namely here via the gear 341, which is rotatable about a drive axis P5, and via the gear 342 coupled to the former, which is fixedly mounted on the shaft 320. The lower shaft 330 is rotatable about an axis P2. Here, too, there is a drive train 346, which is driven via a drive gear 345 which, in turn, is rotatable about the axis P1. However, this is merely one example for the drive of the two repositioning shafts 320, 330; the drive may also be achieved in completely different manner. The rotation of the two shafts 320, 330 about the axes P6, respectively, P2 is preferably synchronized.

In the example shown, the wire nozzle outlet arrangement according to the invention includes a substructure 370, in which the lower shaft 330 is rotatably mounted. This substructure 370 also serves as a base for supporting an upper part 350, which is mounted in the example shown on a carriage 355, which is mounted via the guides 360 so as to be movable in the direction P3 perpendicular to the feed direction X. The upper shaft 320 is rotatably mounted on the upper part about the axis 6. Thus, by moving the carriage 355 in the direction P3, the two shafts 320, 330 may in this way be moved relative to one another parallel to their axial direction. Moreover, the upper part 350 may be adjusted via a height adjustment 351 (in the example shown designed preferably as a lift cylinder) in direction P4 perpendicular to the direction P3 and perpendicular to the feed direction X. In this way, the two shafts 320, 330 may be displaced parallel relative to one another in direction P4.

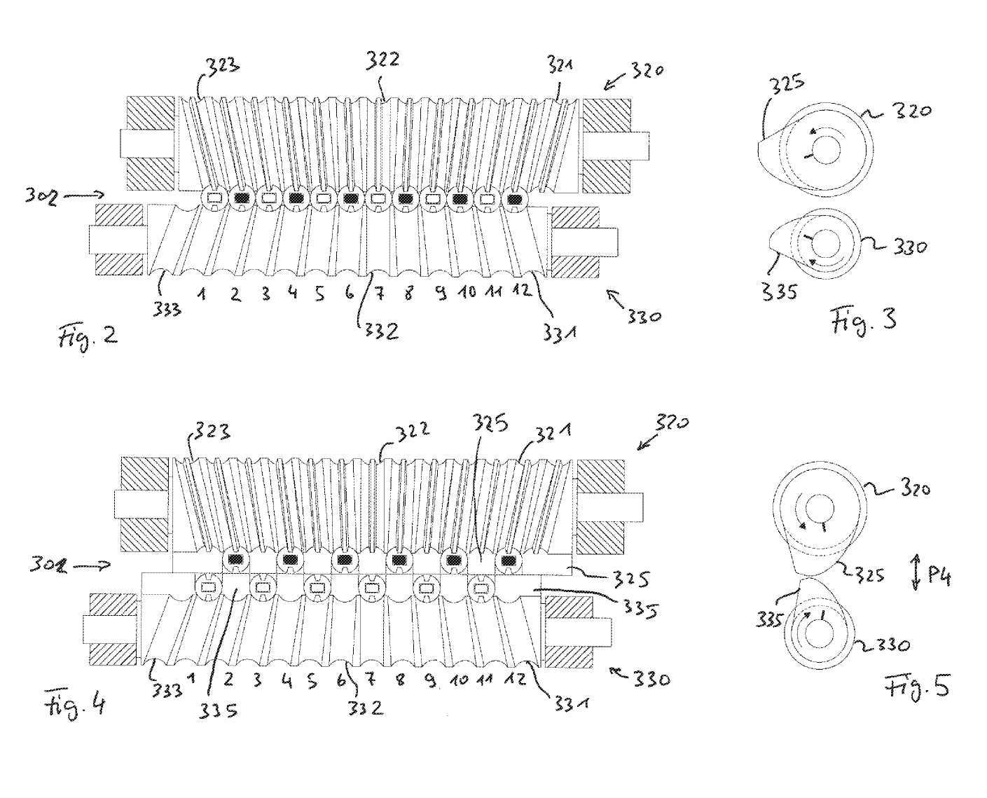

Thus, with the mechanism depicted, the two shafts 320, 330 may be displaced relative to one another in the axial direction and perpendicular thereto. As a result, wire outlet nozzles 302 may be interchanged as is described below with reference to FIGS. 2-9.

In FIG. 2 depicts a specific arrangement of nozzles 302. For the sake of simplicity, these are numbered consecutively from left to right with 1-12. The two shafts 320 and 330 enclose the nozzle arrangement between them, wherein the nozzles 302 are situated next to one another in the sequence of 1-12 in corresponding grooves 321, 322, 323, respectively, 331, 332, 333 of the shafts 320, respectively, 330. The shafts 320, 330 include cams 325, respectively 335 situated in a comb-like manner, which are not shown in FIG. 2, because they are concealed in their rotational position by the shafts 320, 330. These are indicated in the sections in FIG. 3.

The shafts 320, 330—as previously mentioned—may be rotated about their longitudinal axis. A quarter rotation yields the situation as it is depicted in FIGS. 4 and 5. The cams 325, respectively 335 now point toward one another and the shafts 320, 330 distance themselves from one another in direction P4. As is now apparent in FIG. 4, the even numbered nozzles 302 (2, 4, 6, 8, 10, 12) are situated between adjacent cams 325 of the upper shaft 320. Similarly, the odd numbered nozzles 302 (1, 3, 5, 7, 9, 11) are situated between adjacent cams 335 of the lower shaft 330. At the same time, the cams of the one shaft hold each of the opposite lying nozzles 302 between the cams of the respective other shaft. In this situation, which is shown in FIGS. 4 and 5, therefore, the even numbered nozzles are separated from the odd numbered nozzles and spaced apart from one another in direction P4, so that now they may be moved toward one another parallel to their axial direction by the relative movement of the two shafts.

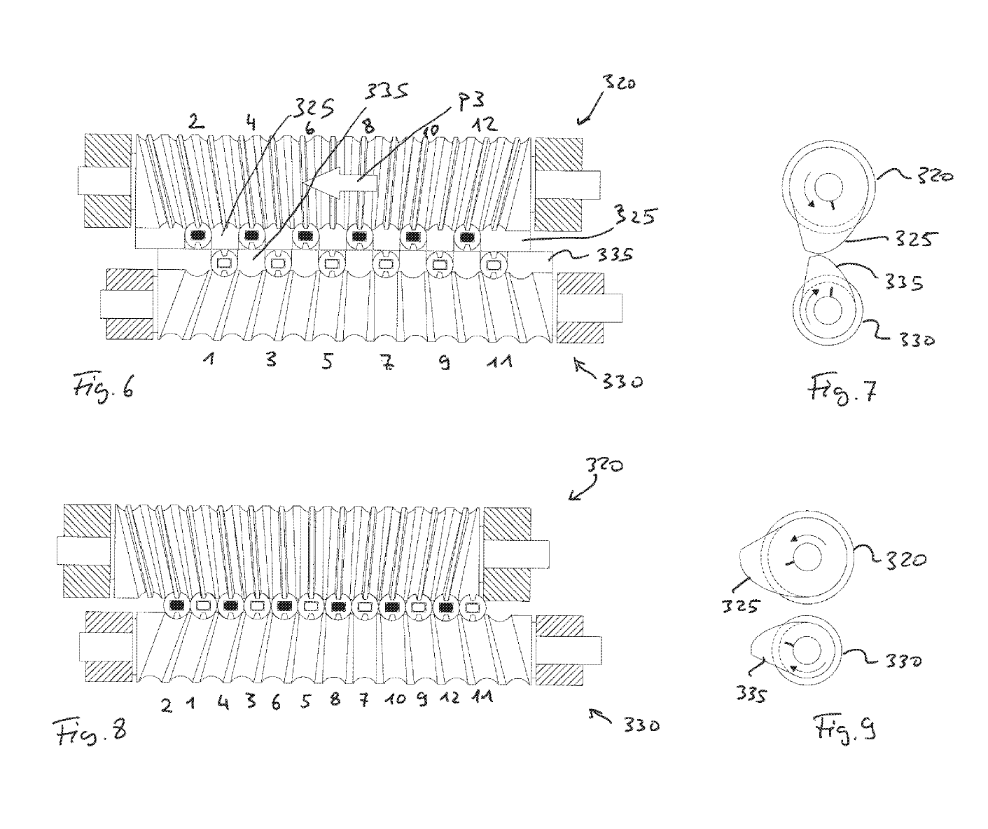

FIGS. 6 and 7 show a situation in which, for example, the upper shaft 320 has been moved to the left relative to the lower shaft 330 in arrow direction P3, as opposed to the situation in FIG. 4. As a result of the comb-like cams 325, respectively, 335, the respective nozzles 302 are entrained, i.e. they follow this displacement movement. FIG. 6 shows a situation, in which the movement has taken place to the left by double the nozzle spacing in the direction of the arrow P3. The nozzles 2, 4, 6, 8, 10, 12 located on the upper shaft 320 are now situated again above exposed grooves of the lower shaft 330. If both shafts are then rotated, the cams disappear from the area between the shafts 320, 330 and the two shafts may again then be moved toward one another. This occurs preferably simultaneously, so that the nozzles 2, 4, 6, 8, 10, 12 associated with the upper shaft 320 may then be inserted again into the intermediate spaces between the nozzles 1, 3, 5, 7, 9, 11 on the lower shaft 330.

This results in the situation shown in FIGS. 8 and 9. As is apparent, the sequence of the nozzles relative to the starting situation in FIG. 2 has been interchanged by the process described; the sequence of nozzles is now 2, 1, 4, 3, 6, 5, 8, 7, 10, 9, 12, 11.

In this way, it is possible, for example, to implement a phase change by interchanging wires within a winding strand, which may be advantageous for the design of the wave winding and for the electromagnetic properties of the wave winding or of the symmetry of the components produced with the wave winding.

1. A wire nozzle outlet arrangement (300), comprising a plurality of wire nozzle outlets (302) situated parallel to one another, each of which guides a winding wire (301) in a wire feed direction (X), wherein the wire outlet nozzles (302) include an outlet opening, through which the winding wire (301) guided in the wire outlet nozzle (302) exits the respective wire outlet nozzle (302),
wherein
the wire outlet nozzle arrangement includes a repositioning device (320, 330) for changing the sequence of the wire outlet nozzles (302) by repositioning the wire outlet nozzles (302).

2. The wire outlet nozzle arrangement (300) according to claim 1,
wherein
the outlet openings of the wire outlet nozzles (302) having a rectangular cross section, wherein the winding wire (301) also has a rectangular cross section.

3. The wire outlet nozzle arrangement (300) according to claim 1,
further comprising
at least two repositioning shafts (320, 330), each mounted so as to rotate about an axis (P6; P2) perpendicular to the wire feed direction (X) spaced apart from one another, between which the wire outlet nozzles (302) are situated.

4. The wire outlet nozzle arrangement (300) according to claim 3,
wherein
the repositioning shafts (320; 330) move relative to one another parallel to their direction of longitudinal extension and perpendicular to the wire feed direction (X).

5. The wire outlet nozzle arrangement (300) according to claim 3,
wherein
at least one of the repositioning shafts (320, 330) is mounted so as to move in a direction (P3) parallel to the wire feed direction (X).

6. The wire outlet nozzle arrangement (300) according to claim 3,
wherein
the repositioning shafts (320; 330) comprise a plurality of indentations (321-323; 331-333) positively engaging with the outsides of the wire outlet nozzles (302).

7. The wire outlet nozzle arrangement (300) according to claim 3,
wherein
both repositioning shafts (320, 330) each include cams (325, 335) spaced apart from one another along their direction of longitudinal extension.

8. The wire outlet nozzle arrangement (300) according to claim 7,
wherein
the spacing between the cams (325, 335) is selected so that precisely one wire outlet nozzle (302) occupies space between the cams.

9. The wire outlet nozzle arrangement (300) according to claim 3,
further comprising
a drive means (341; 345), which drives the repositioning shafts (320; 330) in a rotating manner.

10. A wave winding device, including a wire outlet nozzle arrangement (300) comprising
a plurality of wire nozzle outlets (302) situated parallel to one another, each of which guides a winding wire (301) in a wire feed direction (X), wherein the wire outlet nozzles (302) include an outlet opening, through which the winding wire (301) guided in the wire outlet nozzle (302) exits the respective wire outlet nozzle (302),
wherein
the wire outlet nozzle arrangement includes a repositioning device (320, 330) for changing the sequence of the wire outlet nozzles (302) by repositioning the wire outlet nozzles (302).

11. The wave winding device according to claim 1,
wherein
the outlet openings of the wire outlet nozzles (302) having a rectangular cross section, wherein the winding wire (301) also has a rectangular cross section.

12. The wave winding device according to claim 10, wherein the wire outlet nozzle arrangement (300),
further comprises
at least two repositioning shafts (320, 330), each mounted so as to rotate about an axis (P6; P2) perpendicular to the wire feed direction (X) spaced apart from one another, between which the wire outlet nozzles (302) are situated.

13. The wave winding device according to claim 12,
wherein
the repositioning shafts (320; 330) move relative to one another parallel to their direction of longitudinal extension and perpendicular to the wire feed direction (X).

14. The wave winding device according to claim 12,
wherein
at least one of the repositioning shafts (320, 330) is mounted so as to move in a direction (P3) parallel to the wire feed direction (X).

15. The wave winding device according to claim 12,
wherein
the repositioning shafts (320; 330) comprise a plurality of indentations (321-323; 331-333) positively engaging with the outsides of the wire outlet nozzles (302).

16. The wave winding device according to claim 12,
wherein
both repositioning shafts (320, 330) each include cams (325, 335) spaced apart from one another along their direction of longitudinal extension.

17. The wave winding device according to claim 16,
wherein
the spacing between the cams (325, 335) is selected so that precisely one wire outlet nozzle (302) occupies space between the cams.

18. The wave winding device according to claim 13, wherein the wire outlet nozzle arrangement (300),
further comprises
a drive means (341; 345), which drives the repositioning shafts (320; 330) in a rotating manner.
